(19) United States
(12) Patent Application Publication
(10) Pub. No.: US 2007/0207790 A1
(43) Pub. Date: Sep. 6, 2007

(54) Charging Method And Device In An Intelligent Network

(75) Inventor: Weisong Zang, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 11/680,635

(22) Filed: Mar. 1, 2007

Related U.S. Application Data
(63) Continuation of application No. PCT/CN05/02107, filed on Dec. 7, 2005.

(30) Foreign Application Priority Data
Dec. 7, 2004 (CN) 200410097138.4

(51) Int. Cl. H04M 3/42

(52) U.S. Cl. 455/415

(57) ABSTRACT

An embodiment of the present invention discloses a charging method, including: upon receiving a call from a subscriber, acquiring call-related information of the call, wherein the call-related information comprises visited cell information of the subscriber; acquiring a charging rule according to the visited cell information; and charging the call according to the charging rule. By setting the charging rule for a cell, in a communication process, the SCP can acquire the charging rule according to the cell information after acquiring the call-related information, thereby implementing the charging based on the cell.

### CROSS-REFERENCE TO RELATED APPLICATIONS

This application is a continuation of International Application No. PCT/CN2005/002107 filed on Dec. 7, 2005. This application claims the benefit of Chinese Patent Application No. 200410097138.4 filed on Dec. 7, 2004. The disclosures of the above applications are incorporated herein by reference.

### FIELD

The present disclosure relates to the charging technology in a communication system, and particularly to a charging method and a device in an intelligent network.

### BACKGROUND

The statements in this section merely provide background information related to the present disclosure and may not constitute prior art.

Along with the increasingly fierce competition in mobile communication markets, each communication enterprise makes more and more efforts to compete for customer groups. Customer groups spending extremely high amounts of money on communications are referred to as major clients. To compete for the major clients is the main target of each communication operator. The major clients are usually group clients who have characteristics such as high consumption, good creditability and lower arrears, etc. The loss of a group client may cause disastrous loss of the mobile communication enterprise. In addition, with the wide spread of communication devices, there are more and more mobile communication subscribers, thus the demand for diversified charging becomes higher and higher.

The conventional charging method in an intelligent network is to preset a relationship between a subscriber type and a charging rule for a subscriber in a Service Control Point (SCP), wherein the subscriber may be a “Shenzhouxing” subscriber, an “M-zone” subscriber, a “ruyitong” subscriber, etc. The relationships are shown in Table 1:

TABLE 1

Subscriber type

| | Subscriber | Subscriber | Subscriber | |
|---|---|---|---|---|
| | type1 | type2 | type3 | . . . |
| Charging | Charging | Charging | Charging | . . . |
| rule | rule1 | rule2 | rule3 | |

Upon the foregoing setting, the signaling flow for charging in a communication process in a GSM network is shown in FIG. 1, which includes the following steps:

Step 101: A terminal corresponding to a calling subscriber initiates a call request. A Mobile Switch Center/Visit Location Register/Service Switch Point (MSC/VLR/SSPa) receives the call request, determines that the subscriber is an intelligent network subscriber according to the calling number, triggers subscriber information of the subscriber, and sends to the SCPa of the calling subscriber an Initial Detection Point (IDP) message containing call-related information.

Step 102: Upon receiving the IDP message, the SCPa of the calling subscriber acquires a calling-charging rule from the call-related information, and charges the calling subscriber according to the calling-charging rule. The acquired calling-charging rule includes a charging ratio and a calculating method, etc. Therefore, the SCPa of the calling subscriber can charge the calling subscriber according to the charging rule, a conversation duration, location information of the called subscriber, etc.

Steps 103˜106: The SCPa of the calling subscriber sends a Request Report BCSM (RRBE) message to the MSC/VLR/SSPa, configures a Basic Call State Model (BCSM) that needs reporting, sends to the MSC/VLR/SSPa an application charging message, a Furnish Charging Information (FCI) message, and a connection message to notify the MSC/VLR/SSPa to connect the calling subscriber with the called subscriber.

Steps 107˜110: The MSC/VLR/SSPa sends a Searching for Routing Information message (SRI) to a Home Location Register (HLRb) of the called subscriber. The HLRb, upon receiving the SRI message, sends a roaming number request to the MSC/VLR/SSPb of the called subscriber. The MSC/VLR/SSPb receives the roaming number request, assigns a roaming number for the called subscriber and sends the roaming number to the HLRb via a roaming number response. The HLRb accordingly returns a routing information response.

Step 111: Upon receiving the routing information of the called subscriber returned by the HLRb, the MSC/VLR/SSPa sends an IDP message to the SCPb of the called subscriber according to the routing information, and reporting the call-related information.

Step 112: Upon receiving the IDP message, the SCPb of the called subscriber acquires a called-charging rule according to the call-related information and charges the called subscriber according to the called-charging rule.

Steps 113˜116: The SCPb sends the RRBE message to the MSC/VLR/SSPb of the called subscriber, configures BCSM event that needs reporting, sends to the MSC/VLR/SSPa the application charging message, the FCI message, and a connection message to notify the MSC/VLR/SSPa to connect the called subscriber with the calling subscriber.

Steps 117˜120: The MSC/VLR/SSPa of the calling subscriber sends a call initial message (IAM) to the MSC/VLR/SSPb of the called subscriber. The MSC/VLR/SSPb of the called subscriber, upon receiving the IAM message, searches the called subscriber for the called subscriber state, carries the called subscriber state in an Address Complete Message (ACM) and sends the ACM to the MSC/VLR/SSPa of the calling subscriber. After the called subscriber answers, the MSC/VLR/SSPb sends an answer message to the MSC/VLR/SSPa, and thus communications between the calling subscriber and the called subscriber begin.

Steps 121˜123: After the call finishes and either side disconnects, the MSC/VLR/SSPa reports an Application for Charging Report (ACR) message to the SCPa. After receiving the message, the SCPa generates a bill for the calling subscriber according to the calling-charging rule, and sends a call-release message to the MSC/VLR/SSPa.

Steps 124˜126: The MSC/VLR/SSPa reports the ACR message to the SCPb. The SCPb, after receiving the ACR message, generates a bill for the called subscriber according to the called-charging rule, sends a call-release message to the MSC/VLR/SSPb, and terminates the flow.

In the foregoing Step 102, after receiving the IDP message, the SCPa of the calling subscriber acquires the calling-charging rule according to the call-related information in the IDP message and charges the calling subscriber according to the calling-charging rule, as shown in FIG. 2. These steps are contained in the process:

Step 201: The SCPa acquires the calling number, the called number and location region information according to the call-related information in the IDP message. The location region information includes a calling visit MSCID, a home MSCID of the calling subscriber and a home MSCID of the called subscriber.

Step 202: The SCPa acquires the calling subscriber type such as shenzhouxing, GSM according to the calling number, and acquires the charging rule according to the preset corresponding relationship between the subscriber type and the charging rule.

Step 203: A local communication charging is performed according to the charging rule and the home MSCID of the calling subscriber; a roam communication charging is performed according to the charging rule, the home MSCID of the calling subscriber and the roam MSCID of the calling subscriber; and a long-distance communication charging is performed according to the charging rule, the roam MSCID of the calling subscriber and the home MSCID of the called subscriber.

In the above Step 112, the method of acquiring the called-charging rule and performing the charging on the called subscriber by the SCPb of the called subscriber is identical to that of acquiring the calling-charging rule and performing the charging on the calling subscriber by the SCPs of the calling subscriber.

### SUMMARY

An embodiment of the present invention provides a charging method and an SCP in an intelligent network, and the method and the SCP could perform a cell-based charging.

A charging method may include:

upon receiving a call from a subscriber, acquiring call-related information of the call, wherein the call-related information comprises visited cell information of the subscriber;

acquiring a charging rule according to the visited cell information; and

charging the call according to the charging rule.

A Service Control Point may include:

a component configure to:

acquire the call-related information of the call upon receiving a call from a subscriber, wherein the call-related information comprises a visited cell information of the subscriber;

acquire a charging rule according to the visited cell information; and

charge the call according to the charging rule.

In view of the above, in an embodiment of the present invention, by setting the charging rule for a cell in the SCP, in a communication process, the SCP can acquire the charging rule according to the cell information after acquiring the call-related information, thereby implementing the charging based on the cell.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flowchart of signaling in a communication process in the prior art.

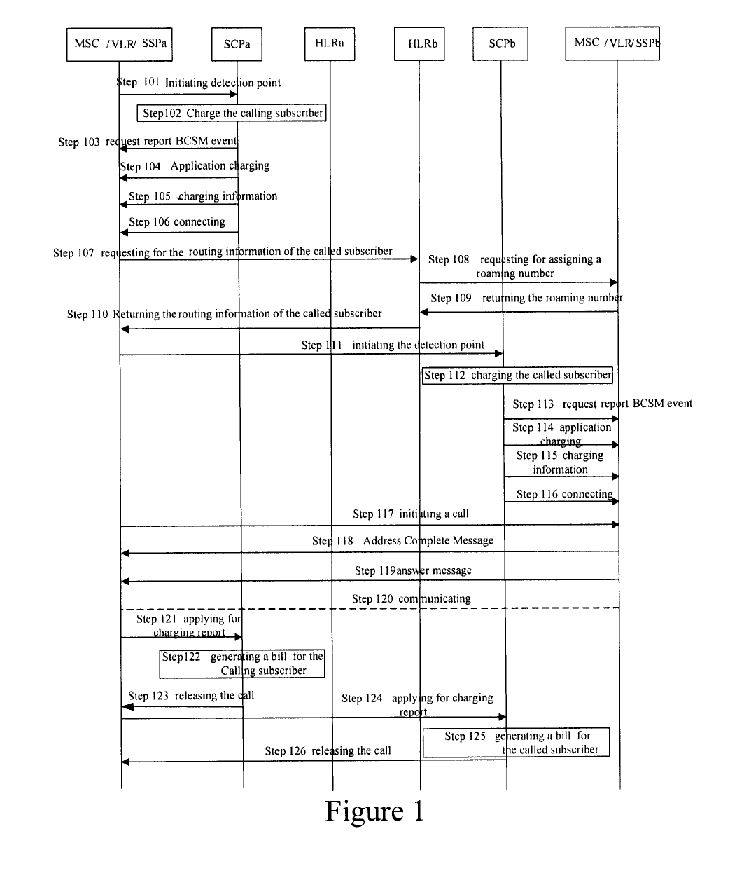

FIG. 2 is a flowchart of the charging rule in a SCP in the prior art.

FIG. 3 is a simplified flowchart of the first embodiment of the present invention.

FIG. 4 is a simplified flowchart of the second embodiment of the present invention.

FIG. 5 is a simplified flowchart of the third embodiment of the present invention.

FIG. 6 is a simplified flowchart of the fourth embodiment of the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It can be seen from the conventional charging process in the intelligent network that, by searching the call-related information, the SCP could acquire the region information MSCID such that it could only charge subscribers based on a region rather than on a cell or a zone. Moreover, the SCP can not carry out a favorable strategy for some more important group customers, thereby leading to less attraction to group customers and less competitiveness of an operator.

In an embodiment of present invention, a charging rule for a cell is preset in an SCP. Upon receiving a call, the SCP acquires the charging rule according to the related information of the call, and acquires the charging rule according to the cell information in the related information and performs a charging on subscriber according to the charging rule.

Embodiments of the invention are hereinafter described.

The first embodiment of the invention is directed to perform the cell-based charging in a GSM network. In order to implement the charging, a corresponding relationship between the subscriber type, the cell and the charging rule is needed to be set in the SCP in advance, as shown in Table 2.

TABLE 2

Subscriber type

| | Subscriber | Subscriber | Subscriber | |
|---|---|---|---|---|
| | type1 | type2 | type3 | . . . |
| Cell ID | Cell ID1 | Cell ID2 | Cell ID3 | . . . |
| Charging | Charging | Charging | Charging | . . . |
| rule | rule1 | rule2 | rule3 | |

In addition, the subscriber can use the charging rule in the above table when the subscriber is in the home cell which the subscriber registered in; therefore a home cell for the subscriber is also needed to be set in the SCP. The corresponding relationship between the subscriber and its home cell in the SCP is shown in Table 3. In a GSM network, as cell IDs are globally numbered in a uniform way, a cell ID can identify a cell uniquely.

TABLE 3

Terminal ID

| | MSISDN1 | MSISDN 2 | MSISDN 3 | . . . |
|---|---|---|---|---|
| Cell ID | CellID1 | CellID2 | CellID3 | . . . |

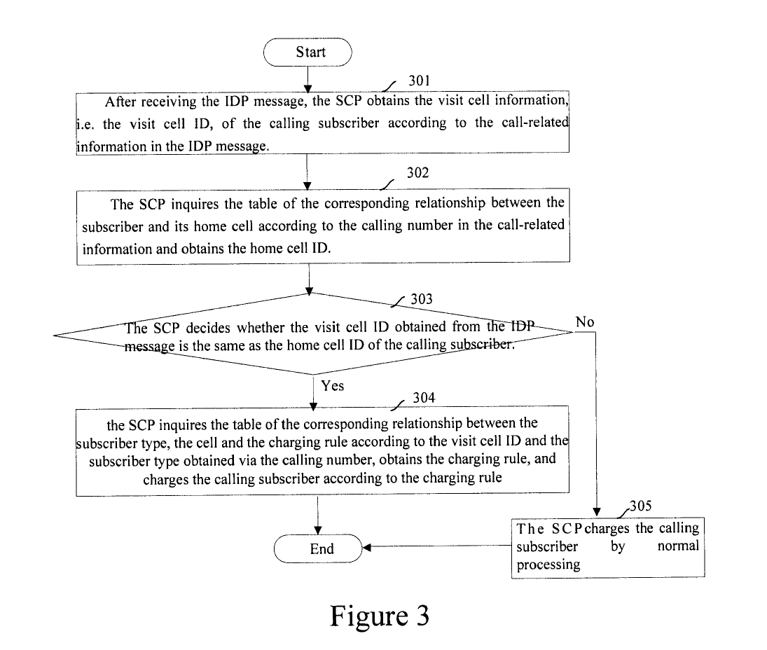

After the above setting, in the communication process, the process of the SCP acquiring a calling-charging rule and performing a charging on the calling subscriber after receiving an IDP message is shown in FIG. 3, which includes a process as follows:

Step 301: After receiving the IDP message, the SCP acquires the visit cell information, i.e. the visit cell ID, of the calling subscriber according to the call-related information in the IDP message.

Step 302: The SCP inquires the table of the corresponding relationship between the subscriber and its home cell according to the calling number in the call-related information and acquires the home cell ID.

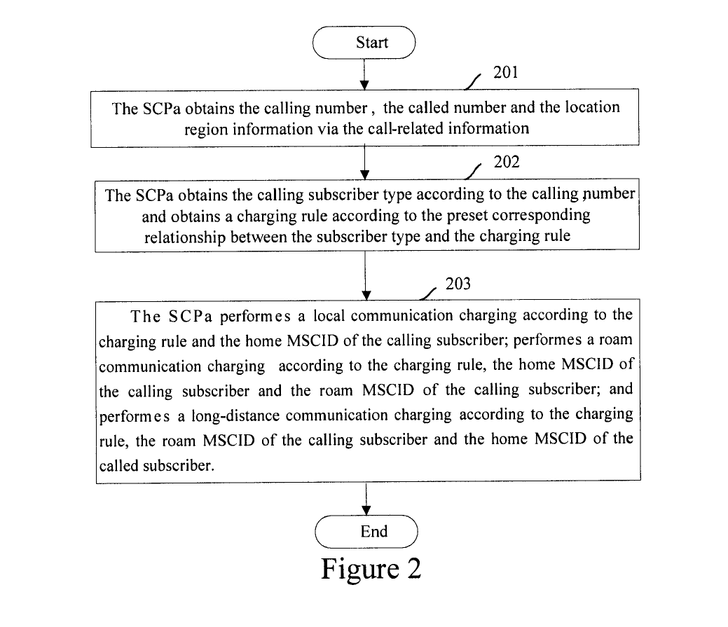

Steps 303˜305: The SCP determines whether the visit cell ID acquired from the IDP message is the same as the home cell ID of the calling subscriber. If the two are identical, the SCP inquires the table of the corresponding relationship between the subscriber type, the cell and the charging rule according to the visit cell ID and the subscriber type acquired via the calling number, acquires the charging rule, and charges the calling subscriber according to the charging rule; otherwise, charges the calling subscriber by normal processing, that is, carries out the process shown in FIG. 2. In this embodiment, the corresponding relationship between the subscriber and its home cell is also set in the SCP, thus the subscriber can be charged according to the charging rule corresponding to its home cell when the subscriber is in its home cell. Therefore, the case that the subscriber is still charged according to the charging rule corresponding to its home cell when the subscriber is in other cells except for its home can be avoided.

Alternatively, in another embodiment, Table 3 may not be set, that is, the subscriber home cell is not involved in charging. In this case, after Step 301, Step 304 may be performed directly. That is, the SCP inquires the table of the corresponding relationship between the subscriber type, the cell and the charging rule according to the visit cell ID and the subscriber type acquired via the calling number, so as to acquire the charging rule, and charges the calling subscriber according to the charging rule.

To improve the competition ability in terms of major clients, i.e. group customers, in the second embodiment of the invention, a cell-based charging rule for group customers is further provided, which will be described hereinafter.

In the second embodiment of the invention, the cell-based charging rule for the group customers is further provided. That is, in the second embodiment, the terminal ID in Table 3 may also be replaced by the group ID. As in the communication process, the subscriber information acquired by the SCP is the calling and/or called terminal ID information. Besides what is set in the embodiment one, a corresponding relationship between the terminal ID and the group ID also needs to be set, as shown in Table 4:

TABLE 4

Terminal ID

| | MSISDN1 | MSISDN 2 | MSISDN 3 | . . . |
|---|---|---|---|---|
| Group ID | GroupID1 | GroupID 2 | GroupID 3 | . . . |

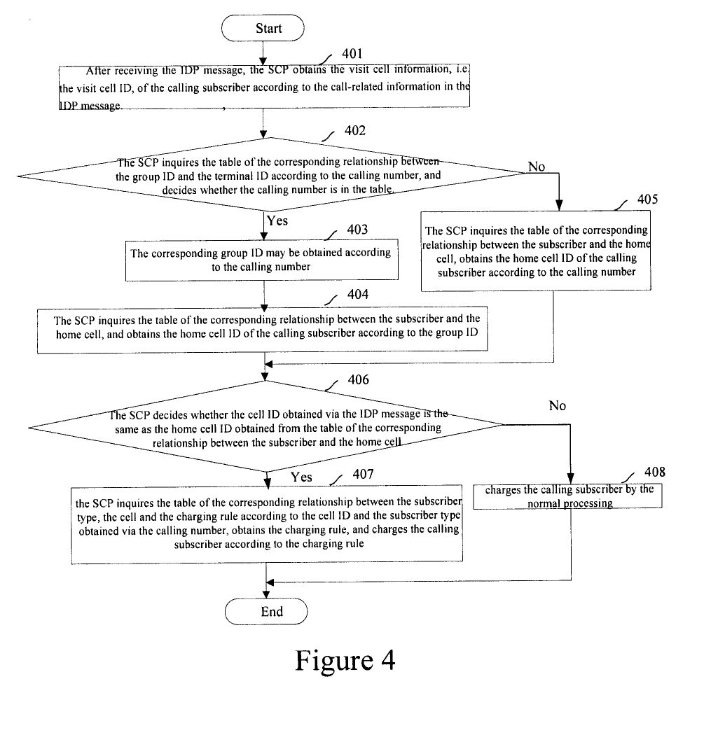

Upon setting the Group ID, in the communication process, the process of the SCP acquiring a calling-charging rule and performing a charging on the calling subscriber according to the calling-charging rule after receiving an IDP message is shown in FIG. 4, which includes a process as follows:

Step 401: After receiving the IDP message, the SCP acquires the visit cell information, i.e. the visit cell ID, of the calling subscriber according to the call-related information in the IDP message.

Step 402: The SCP inquires the table of the corresponding relationship between the group ID and the terminal ID according to the calling number, and determines whether the calling number is in the table. If the calling number is in the table, Step 403 is performed; otherwise, Step 405 is performed.

Step 403: The corresponding group ID may be acquired according to the calling number, and then Step 404 is performed.

Step 404: The SCP inquires the table of the corresponding relationship between the subscriber and the home cell, and acquires the home cell ID of the calling subscriber according to the group ID, and then performs Step 406.

Step 405: The SCP inquires the table of the corresponding relationship between the subscriber and the home cell, acquires the home cell ID of the calling subscriber according to the calling number, and then performs Step 406.

Steps 406˜408: The SCP determines whether the cell ID acquired via the IDP message is the same as the home cell ID acquired from the table of the corresponding relationship between the subscriber and the home cell. If the two are identical, the SCP inquires the table of the corresponding relationship between the subscriber type, the cell and the charging rule according to the cell ID and the subscriber type acquired via the calling number, acquires the charging rule, and charges the calling subscriber according to the charging rule; otherwise, charges the calling subscriber by the normal processing, that is, carries out the process shown in FIG. 2.

After the SCP receives the IDP message, the process of the SCP acquiring the called-charging rule and charging the called subscriber according to the called-charging rule is the same as the foregoing flow, except that the calling subscriber should be replaced by the called subscriber when implementing the process. By setting a corresponding charging cell and charging zone for a group subscriber, this embodiment implements individual charging for the group subscriber such that a favorable policy is implemented for the group subscriber, and the attraction to the group subscriber and the competitiveness of operators are improved.

In the foregoing first and second embodiments, the charging rule should be set for each cell. However, the charging rule types are finite. If each cell has one kind of charging rule, a great repetition of setting the charging rules may be caused. Therefore, a third embodiment is provided in the invention.

In the third embodiment, several cells with the same charging rule are set as a zone. A zone is a set of several cells in a certain region. The cells in the zone physically could either be the ones in a continuously covered area, or the ones in a discontinuously covered area. The Charging zones are numbered uniformly, which may be identified by an 8-bits decimal string, such as 10755022, wherein 0755 represents a region number and 022 represents a zone number in the region. In addition, there are many zones set in a SCP, and if each zone is assigned a charging rule, charging rules will become complicated. Furthermore, it is not necessary to set one charging rule for each zone. Therefore, the charging zones are divided into different zone classes, thus each zone class needs one charging rule, and the SCP load is decreased.

In this embodiment, the corresponding relationship between a subscriber and a charging zone is set in the SCP in advance, as shown in Table 5:

TABLE 5

Terminal ID or group ID

| | MSISDN1 | GroupID 2 | MSISDN 3 | . . . |
|---|---|---|---|---|
| Charging | Zone | Zone | Zone number 3 | . . . |
| zone | number 1 | number 2 | | |

A common subscriber or a group subscriber may register its own charging zone according to the inhabitance area or working area. Then the SCP may set the corresponding relationship between the charging zone and the subscriber terminal ID or group ID in a charging zone table, wherein the corresponding relationship between the group ID and the terminal ID is the same as the second embodiment, as shown in Table 4. As a charging zone corresponds to one or more cells, the corresponding relationship between the charging zone information and the cell information should be set. Table 6 shows a relationship between the charging zone and the cell.

TABLE 6

| | Visit Zone number | | | |
|---|---|---|---|---|
| | VisitZone1 | VisitZone 2 | VisitZone 3 | . . . |
| Zone Number | Zone number 1 | Zone number 2 | Zone number 3 | . . . |
| Cell name | CellName1 | CellName 2 | CellName 3 | . . . |
| Zone class | ZoneClass1 | ZoneClass2 | ZoneClass3 | . . . |

A subscriber charging type table is shown in Table 7 when the zone class is set.

TABLE 7

| | Subscriber type | | | |
|---|---|---|---|---|
| | Subscribertype1 | Subscribertype2 | Subscribertype3 | . . . |
| Zone class | ZoneClass1 | ZoneClass2 | ZoneClass3 | . . . |
| Charging | Charging rule1 | Charging rule2 | Charging rule3 | . . . |
| rule | | | | |

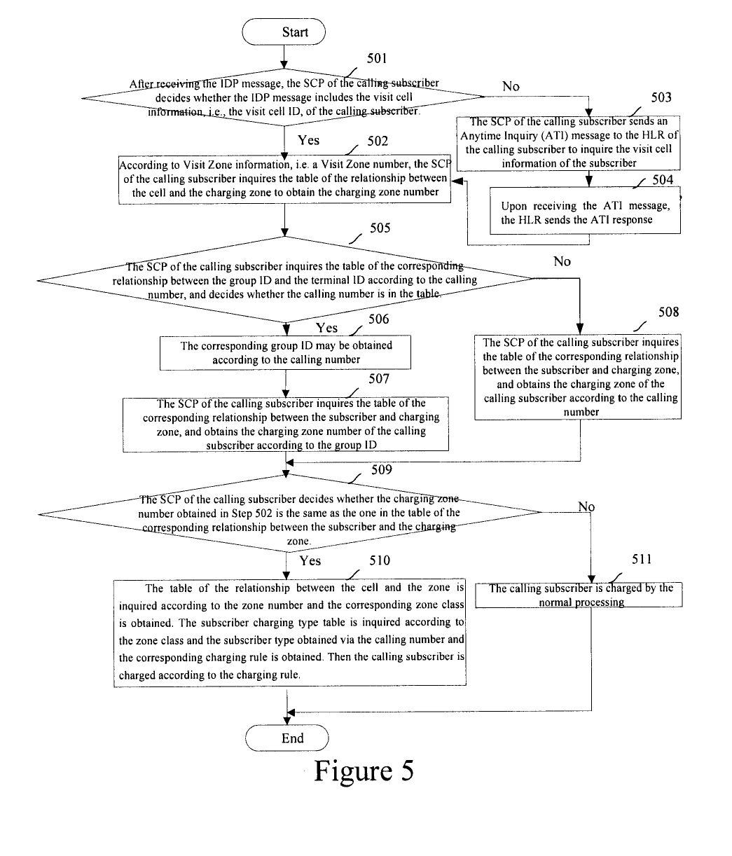

After the above setting, in the communication process, the process of the SCP of the calling subscriber acquiring a calling-charging rule and performing a charging on the calling subscriber according to the calling-charging rule after receiving an IDP message is shown in FIG. 5, which includes a process as follows:

Step 501: After receiving the IDP message, the SCP of the calling subscriber determines whether the IDP message includes the visit cell information, i.e., the visit cell ID, of the calling subscriber. If so, Step 502 is performed; otherwise, Step 503 is performed.

Step 502: According to Visit Zone information, i.e. a Visit Zone number, the SCP of the calling subscriber inquires the table of the relationship between the cell and the charging zone to acquire the charging zone number, and performs Step 505.

Step 503: The SCP of the calling subscriber sends an Anytime Inquiry (ATI) message to the HLR of the calling subscriber to inquire the visit cell information of the subscriber, and then performs 504.

Step 504: Upon receiving the ATI message, the HLR of the calling subscriber inquires the visit cell information, i.e. the visit cell ID, of the calling subscriber, carries the visit cell ID in an ATI response, sends the ATI response to the SCP of the calling subscriber, and then returns to Step 502.

Step 505: The SCP of the calling subscriber inquires the table of the corresponding relationship between the group ID and the terminal ID according to the calling number, and determines whether the calling number is in the table. If the calling number is in the table, Step 506 is performed; otherwise, Step 508 is performed.

Step 506: The corresponding group ID may be acquired according to the calling number, and then Step 507 is performed.

Step 507: The SCP of the calling subscriber inquires the table of the corresponding relationship between the subscriber and charging zone, and acquires the charging zone number of the calling subscriber according to the group ID, and then performs Step 509.

Step 508: The SCP of the calling subscriber inquires the table of the corresponding relationship between the subscriber and charging zone, and acquires the charging zone of the calling subscriber according to the calling number, and then performs Step 509.

Step 509: The SCP of the calling subscriber determines whether the charging zone number acquired in Step 502 is the same as the one in the table of the corresponding relationship between the subscriber and the charging zone. If the two are identical, Step 510 is performed; otherwise, Step 511 is performed.

Step 510: The table of the relationship between the cell and the zone is inquired according to the zone number and the corresponding zone class is acquired. The subscriber charging type table is inquired according to the zone class and the subscriber type acquired via the calling number and the corresponding charging rule is acquired. Then the calling subscriber is charged according to the charging rule.

Step 511: The calling subscriber is charged by the normal processing, that is, the process shown in FIG. 2 is performed.

In the communication process, the process of the SCP of the called subscriber acquiring a called-charging rule and performing a charging on the called subscriber according to the called-charging rule after receiving an IDP message is similar to the process in FIG. 5, except that the calling subscriber in FIG. 5 should be replaced by the called subscriber. This embodiment sets one or more cells as a zone, sets a charging rule and a zone class for the zone, and sets a charging rule for the zone class, which greatly reduces the repetition of setting charging type and decreases the SCP load.

The foregoing embodiments are the realization of the invention in a GSM network. Certainly the invention embodiment may also be used in a CDMA network or in other intelligent networks. The implementation of the present invention embodiment in the CDMA network is similar to the above embodiments. However, the signaling flow and the cell information ID in the CDMA network are different to the above description. Herein, implementation of the spirit of the present invention embodiment in the CDMA network is described in a fourth embodiment.

In the fourth embodiment, the table of the corresponding relationship between the subscriber and the charging zone, a table of the corresponding relationship between the cell and the zone and the subscriber charging type table are preset in the SCP.

The table of the corresponding relationship between the subscriber and the charging zone and the subscriber charging type table are the same as that in the third embodiment, as shown in Tables 5 and 7. In a CDMA network, a cell ID is unique when in the corresponding MSC area, thus a cell ID in a CDMA network could not uniquely identify a cell in the whole network unless it is used together with a MSC number. The table of the corresponding relationship between the cell and the zone is shown in Table 8:

TABLE 8

| | Location region ID | | | |
|---|---|---|---|---|
| | MSCID1 | MSCID2 | MSCID3 | . . . |
| Cell ID | CellID1 | CellID2 | CellID3 | . . . |
| Zone number | Zone number 1 | Zone number 2 | Zone number 3 | . . . |
| Cell name | CellName1 | CellName 2 | CellName 3 | . . . |
| Zone class | ZoneClass1 | ZoneClass2 | ZoneClass3 | . . . |

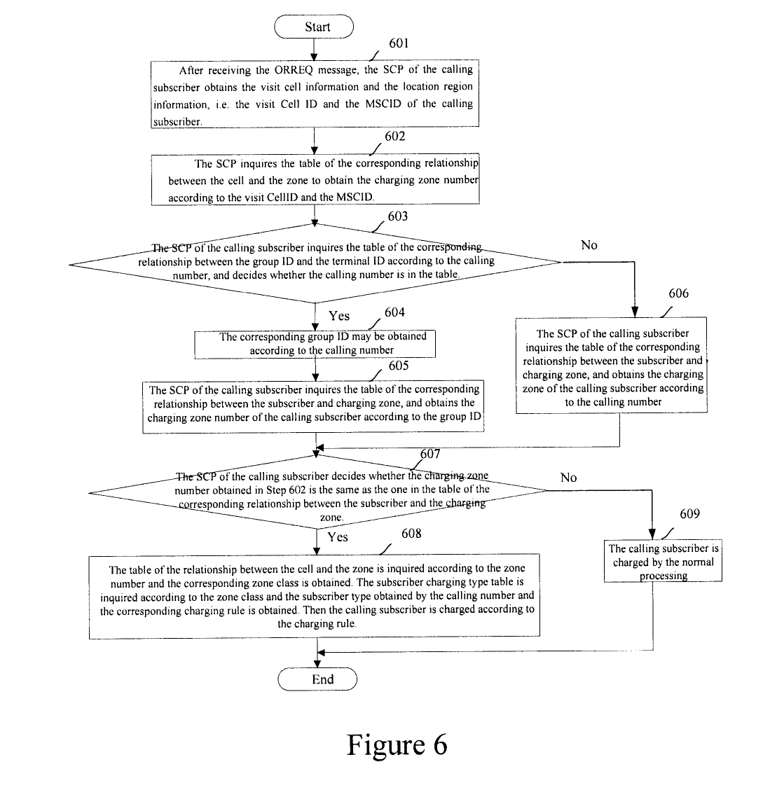

After the foregoing setting, in the communication process, the signaling flow is basically similar to that in the prior art. In this embodiment, the process of the SCP of the calling subscriber acquiring the calling-charging rule and performing a charging on the calling subscriber according to the calling-charging rule after receiving an original request message ORREQ sent by the MSC of the calling subscriber along with the call-related information, is shown in FIG. 6. The special steps are as follows:

Step 601: After receiving the ORREQ message, the SCP of the calling subscriber acquires the visit cell information and the location region information, i.e. the visit Cell ID and the MSCID of the calling subscriber.

Step 602: The SCP inquires the table of the corresponding relationship between the cell and the zone to acquire the charging zone number according to the visit Cell ID and the MSCID.

Step 603: The SCP of the calling subscriber inquires the table of the corresponding relationship between the group ID and the terminal ID according to the calling number, and determines whether the calling number is in the table. If the calling number is in the table, Step 604 is performed; otherwise, Step 606 is performed.

Step 604: The corresponding group ID may be acquired according to the calling number, and then Step 605 is performed.

Step 605: The SCP of the calling subscriber inquires the table of the corresponding relationship between the subscriber and charging zone, and acquires the charging zone number of the calling subscriber according to the group ID, and then performs Step 607.

Step 606: The SCP of the calling subscriber inquires the table of the corresponding relationship between the subscriber and charging zone, and acquires the charging zone of the calling subscriber according to the calling number, and then performs Step 607.

Step 607: The SCP of the calling subscriber determines whether the charging zone number acquired in Step 602 is the same as the one in the table of the corresponding relationship between the subscriber and the charging zone. If the two are identical, Step 608 is performed; otherwise, Step 609 is performed.

Step 608: The table of the relationship between the cell and the zone is inquired according to the zone number and the corresponding zone class is acquired. The subscriber charging type table is inquired according to the zone class and the subscriber type acquired by the calling number and the corresponding charging rule is acquired. Then the calling subscriber is charged according to the charging rule.

Step 609: The calling subscriber is charged by the normal processing, that is, the process shown in FIG. 2 is performed.

In the communication process, the process of the SCP of the called subscriber receiving answer information TANSWER sent from the MSC of the called subscriber, acquiring the called-charging rule according to the information and performing a charging on the called subscriber according to the called-charging rule is basically identical to that in FIG. 6, except that the calling subscriber should be replaced by the called subscriber and the ORREQ should be replaced by the TANSWER message.

In view of the above, in the embodiments of the present invention, by setting the corresponding relationship between the cell and the charging rule for the cell in the SCP, in a communication process, the SCP can acquire the charging rule according to the cell information after acquiring the call-related information, thereby implementing the cell-based charging. The corresponding relationship between the subscriber and its home cell is also set in the SCP, thus the subscriber can be charged according to the charging rule corresponding to its home cell when the subscriber is in its home cell. Therefore, the case that the subscriber is still charged according to the charging rule corresponding to its home cell when the subscriber is in other cells except for its home can be avoided. Furthermore, the invention sets one or more cells as a zone, sets a charging rule and a zone class for the zone, and sets a charging rule for the zone class, which greatly reduces the repetition of setting charging type and decreases the SCP load. In addition, by setting a corresponding charging cell and charging zone for a group subscriber, the invention implements individual charging for the group subscriber such that the attraction to the group subscriber and the competitiveness of operators are improved.

Though the present invention has been illustrated and described by some preferred embodiments, those skilled in the art should understand that various changes may be made in form and detail without departing from the spirit and the scope of the present invention and therefore should be covered in the protection scope of the present invention assigned by the appended claims and its equivalents.

What is claimed is:

1. A charging method comprising:
upon receiving a call from a subscriber, acquiring call-related information of the call, wherein the call-related information comprises visited cell information of the subscriber;
acquiring a charging rule according to the visited cell information; and
charging the call according to the charging rule.

2. The method of claim 1, wherein the process of acquiring the charging rule comprises:
acquiring home cell information of the subscriber, if the visited cell information is consistent with the home cell information of the subscriber, and
acquiring the charging rule according to the home cell information of the subscriber.

3. The method of claim 1, wherein the visited cell information comprises a visited cell ID and an ID of a mobile switch center which a visited cell is located in; and
acquiring the charging rule according to the visited cell ID and the ID of a mobile switch center.

4. The method of claim 1, further comprising:
acquiring a type of the subscribe; and
acquiring the charging rule according to the visited cell information and the type of the subscriber.

5. The method of claim 1, further comprising:
presetting zone information comprising cell information of at least one cell.

6. The method of claim 5, further comprising:
acquiring first zone information which the visited cell information is subjected to; and
acquiring the charging rule according to the first zone information.

7. The method of claim 5, further comprising:
acquiring first zone information which the visited cell information is subjected to;
acquiring class information of the first zone according to the first zone information, and
acquiring the charging rule according to class information of the first zone.

8. The method of claim 5, further comprising:
acquiring home cell information of the subscriber;
if the visited cell information is consistent with the home cell information of the subscriber, acquiring second zone information which the home cell information is subjected to; and
acquiring the charging rule according to the second zone information of the subscriber.

9. The method of claim 1, wherein the subscriber is a group user, the process of acquiring a charging rule comprises:
acquiring information of the subscriber as a group user according to the group number of the subscriber;
acquiring home cell information of the subscriber corresponding to the group number of the subscriber; and
if the visited cell information is consistent with the home cell information of the subscriber, acquiring the charging rule according to the home cell information of the subscriber.

10. The method of claim 5, wherein the subscriber is a group user, the process of acquiring a charging rule comprises:
acquiring information of the subscriber as a group user according to the group number of the subscriber;
acquiring home cell information of the subscriber corresponding to the group number of the subscriber; and
if the visited cell information is consistent with the home cell information of the subscriber, acquiring a second zone information which the home cell information is subjected to; and
acquiring the charging rule according to the second zone information of the subscriber.

11. A Service Control Point, comprising:
a component configure to:
acquire the call-related information of the call upon receiving a call from a subscriber, wherein the call-related information comprises a visited cell information of the subscriber;
acquire a charging rule according to the visited cell information; and
charge the call according to the charging rule.

12. The Service Control Point of claim 11, wherein the component is further configured to acquire home cell information of the subscriber if the visited cell information is consistent with the home cell information of the subscriber, and acquire the charging rule according to the home cell information of the subscriber.

13. The Service Control Point of claim 11, wherein the component is further configured to acquire a type of the subscribe; and
acquire the charging rule according to the visited cell information and the type of the subscriber.

14. The Service Control Point of claim 11, wherein the component is further configured to preset correspondence between a group number of a group user and home cell information of the group user.

15. The Service Control Point of claim 14, wherein the component is further configured to acquire information of the subscriber as a group user according to the group number of the subscriber;
acquire home cell information of the subscriber corresponding to the group number of the subscriber; and
acquire a charging rule according to the home cell information of the subscriber, if the visited cell information is consistent with the home cell information of the subscriber.

16. The Service Control Point of claim 11, wherein the component is further configured to preset zone information comprising cell information of at least one cell.

17. The Service Control Point of claim 16, wherein the component is further configured to acquire first zone information which the visited cell information is subjected to; and
acquire the charging rule according to the first zone information.

18. The Service Control Point of claim 16, wherein the component is further configured to acquire home cell information of the subscriber;
acquire second zone information which the home cell information is subjected to, if the visited cell information is consistent with the home cell information of the subscriber; and
acquire the charging rule according to the second zone information of the subscriber.
